(19) United States
(12) Patent Application Publication
(10) Pub. No.: US 2024/0052875 A1
(43) Pub. Date: Feb. 15, 2024

(54) WALL MOUNTING ASSEMBLY

(71) Applicant: Food Grade Solutions, LLC, Fowler, CA (US)

(72) Inventor: James Tjerrild, Clovis, CA (US)

(21) Appl. No.: 17/819,530

(22) Filed: Aug. 12, 2022

(51) Int. Cl. F16B 43/00; F16B 13/08; F16B 33/00

(52) U.S. Cl. CPC F16B 43/001; F16B 13/0808; F16B 33/004; F16M 13/02

(57) ABSTRACT

Embodiments include a mounting assembly for securing a supported element to a wall structure at a distance from the wall, and configured to surround a moly bolt fastener head protruding from the wall and form a moisture seal surrounding the fastener head. The mounting assembly comprises an elongated body with an inner passageway extending between first and second ends and an inner void area configured to cover a fastener head on the wall surface. The inner passageway receives a bolt securing the mounting assembly to the wall structure, and a bottom ring gasket surrounding the inner passageway is positioned to engage the wall surface to form a moisture barrier surrounding the inner passageway. A shank gasket has a central opening aligned with the inner passageway and is configured to form a moisture seal of the shank portion of the bolt inserted to attach the assembly to the wall.

### BACKGROUND

The present invention relates to a mounting assembly for securing an object to a wall, ceiling, or other support structure. More specifically, the invention relates to a mounting assembly for securing an object to a wall/ceiling so the object is positioned at a suitable distance from the wall surface, as is desirable in a food processing or other specialized manufacturing facility. The mounting assembly may be secured at a threaded opening in the wall, such as a threaded fastener assembly installed in a wall panel construction of a food processing or a pharmaceutical manufacturing facility, and an upper surface of the mounting assembly is located a suitable distance away from the wall for mounting an object spaced from the surface of the wall.

Food processing and pharmaceutical processing facilities are typically constructed with interior walls having metal sheet stock covering, commonly stainless steel sheet material, with minimal or no ledges, seams or horizontal surfaces in order to minimize or eliminate the presence of surfaces that are prone to gather dust or debris and to provide interior walls that are easily washed. It is common for such facilities to be constructed of insulated metal panels (IMPs), which are large panels formed of a steel outer layers and an interior foam core. The IMPS are joined together to provide an interior metal wall surface that is easily washed and minimizes collection of dust, debris and moisture. The IMP segments are typically joined together using a technique of overlapping metal covering at the seam and securing the metal cover of two panels with a fastener assembly, often a molly-bolt assembly.

It is often necessary to include mounting devices for securing pipes, conduit, tubes and other objects to the walls. Conventional mounting devices and methods are often difficult to install, inspect and clean, and are prone to contamination that is unsuitable or undesirable for such applications. Further, it may be necessary to comply with special regulations for such facilities, including regulations or requirements for food and drug preparation locations which often require objects such as pipes, conduits or tracking to be positioned a distance away from the wall surface. Therefore, conventional mounting systems for mounting pipes, conduits, and other objects to vertical and horizontal interior walls may not be suitable for use in such facilities. Further, securely mounting objects to the walls constructed from IMPS is challenging, requiring secure attachment to the metal cover of the wall panel while also avoiding or minimizing any upward-facing surfaces which are prone to collect contaminants such as dust or moisture. In addition, conventional mounting systems are often mounted directly onto the wall and result in small gaps between the mounting system and the wall. Such gaps are not easily accessible for inspection or cleaning. As another example, some conventional mounting systems include exposed threaded surfaces that are difficult to clean, and which tend to collect debris and/or allow for moisture to enter into the wall. Conventional mounting systems may require disassembly to achieve an adequate level of cleaning, which is difficult and time consuming, and at times impossible, depending on the installation method and structure. Thus, there is a need for an improved fastener system for securely attaching objects (such as conduit, pipes etc.) to a wall structure, particularly walls constructed of IMPs, in a manner that resists collection of dust and moisture and provides spacing form the wall surface so it may be easily cleaned.

There is also a need for a mounting assembly that may be secured to an existing fastener assembly installed in a wall. For applications such as food preparation or pharmaceutical manufacturing facilities, the walls and ceilings are often constructed of IMP, which are essentially wall segments that are secured together using a “blind anchor” device, typically using an device that may be described as an “molly-bolt” type of fastener, that has threaded sleeve to be inserted into a hole in the IMP panel wherein the device is locked into place using a threaded bolt which causes the threaded sleeve to collapse. A popular example of such a fastener device that is often used for production facilities is marketed under the brand name Fab-Lok®— a fastener device marketed by Elco Construction Products. In this example, a Fab-Lok® molly bolt is inserted into an opening and tightened into place by compressing against the outer and inner surfaces of the metal covering of the IMP. More specifically, a center bolt is tightened into a threaded opening of the device, which then causes the portion of the assembly residing within the wall to collapse, and thereby expand, and moved into position of being forced against the inner surface of the IMP metal cover. Once the Fab-Lok®, or similar moly bolt device, is installed and locked into place, the center bolt may be removed to expose the threaded opening, or it may be left in place. Regardless, the upper cuff or head of the molly bolt assembly remains on, and protrudes from, the surface of the wall. This results in a ledge that is prone to gathering dust and moisture. Further, there is a risk that moisture will enter into a gap between the molly bolt head and the wall surface and thereby enter into the wall, a risk that is minimized, but not eliminated, by employing gasket washers. In addition, the center bolt of the fastener assembly may allow moisture to pass along the threading and enter the wall, and if the center bolt is removed, the treaded opening of the device is exposed, allowing moisture to enter into the wall.

For these reasons, conventional use of molly bolt fastener systems presents problems for mounting articles such as conduit or brackets to an IMP wall panel, particularly in situations in which it is desirable to attach a mounted article so it resides a distance away from the wall, such as being spaced at least 1 inch away from the wall as is often required for food preparation facilities. Once the molly bolt fastener is installed, the upper portion of the device protruding from the surface of the wall panel presents an obstacle for cleanly mounting a structure (such as conduit) directly to the wall. Further, the bolt head of the center bolt, which is threaded into the molly bolt device, also protrudes from the wall, and removal of the bolt results in an exposed threaded opening which allows to contaminants or moisture to enter directly into the wall.

These problems are magnified when considering use of a molly bolt fastener, such as the Fab-Lok® device, that is already installed into a wall panel, such as is the case when joining IMP panels together. The head of the molly bolt assembly protrudes from the wall surface, which presents an obstacle for attaching structures to the wall, and does not provide an optimal mounting surface for securely fastening brackets or conduit to the wall. Alternatively, if a bracket (such as a mounting plate or the like) is mounted under the molly-bolt head, the result is undesirable because the molly bolt head cannot be removed. This deficiency of conventional use of molly bolt devices is depicted in FIG. 8 of the present disclosure, which shows a prior art mounting method using a molly-bolt fastener to attach a metal bracket to a wall. In this example of a conventional and recommended use of the molly bolt fastener, the mounted bracket cannot be removed because it is sandwiched between the wall surface and the head of the molly bolt device. In addition, such use of conventional mounting devices and methods demonstrates that such assemblies, when installed, are susceptible to collection of dust and debris on horizonal flat surfaces, and are susceptible to moisture contamination due to insufficient gasket seal and/or resulting from ineffective installation of washer gaskets.

Accordingly, there is a need for wall mounting assemblies that are suitable for locations requiring a high degree of cleanliness and spaced apart from a wall surface which can securely support a load when installed in a wall panel, are easy to inspect and clean, and which are compatible for use with molly-bolt fasteners, such as Fab-Lok® devices, that protrude from the surface of a wall.

### SUMMARY OF THE INVENTION

The invention disclosed herein is intended to solve the issues and problems identified with conventional devices and methods for mounting a supported element, such as pipes or conduit, to a wall, ceiling, or other support structure, and to provide enhanced sanitation suitable for food preparation and manufacturing applications. Specifically, the present invention provides an apparatus and method that address several issues associated with traditional mounting mechanisms, including resistance from collection of dust and debris, resisting moisture/water contamination into the wall, enhanced ability to wash the wall by providing suitable spacing form the wall surface, enhanced stability and disbursement of the load for securing objects to a wall, and compatibility for use of legacy-type molly-bolt fastener assemblies such as Fab-Lok® brand products that are installed in laminated insulated wall panels commonly used in food processing facilities. Such conventional molly-bolt type of fastener devices are generally considered “blind” fasteners installed into a wall with a fastener head protruding on the wall surface, and are used to secure wall panels together or to provide a threaded opening in a wall for securing objects with a threaded bolt. An example of such conventional fastener device is disclosed in U.S. Pat. Nos. 3,667,340.

Exemplary embodiments of the present inventions, as shown and described herein, provide a mounting assembly configured to be secured to a wall panel at a threaded opening in the wall structure, such as the threaded opening of an existing, or selectively installed, molly bolt device. When secured in place, the mounting assembly is configured to provide a moisture barrier surrounding the threaded opening, and provide a mounting surface positioned a suitable distance from the wall structure for abutment of a supported element (such as a conduit, pipe, bracket or other structure) that is thereby secured to the assembly at a distance from the wall. Further, the mounting assembly is configured to provide a moisture-sealing barrier along an extent of the bolt fastener (i.e., the fastener assembly installed to secure the assembly in place on the wall and to secure the supported element). Other features and benefits are also provided by the present disclosure, which will be apparent to persons skilled in the art, including features providing structural rigidity of the assembly, prevention of dust and debris collection, simplicity of installation and prevention of mis-installation, and adaptability for mounting a variation of supported elements.

One exemplary embodiment, as is shown and described herein, provides a mounting assembly that may be installed to a wall structure for securing a supported element to the wall structure having a molly-bolt anchor head surrounding a threaded opening. The assembly has an elongated body having an inner passageway passing between a first end and a second end of the body, and an inner void area that is configured to receive the protruding head of a molly-bolt fastener device. The inner passageway is configured to receive a bolt for securing the mounting assembly to the wall structure, and a bottom gasket that is formed of a circumferential ring of rubber-like material surrounds the inner passageway and is positioned to engage with a wall surface to form a moisture barrier surrounding the inner passageway. The assembly also provides a shank gasket comprised of a gasket body with a central opening aligned with the inner passageway. The shank gasket is configured to form a moisture seal surrounding a shank portion of a bolt that is inserted through the elongated body for mounting the assembly to a wall structure. The shank gasket body may have a non-circular outer periphery, such as a hexagonal outer peripheral shape, which engages with a mating shape of a recess in the upper portion of the assembly body. This arrangement of mating non-circular shaped gasket body and recess provides resistance from rotating the shank gasket when the bolt is inserted into the assembly, to assure that the shank gasket forms a seal along a portion of the bolt when fully threaded into position.

Another exemplary embodiment provides a method of mounting a supported element to a wall structure using a molly-bolt anchor having a fastener head protruding from the wall and a central threaded opening. The method comprises the steps of providing a mounting assembly having an elongated body with an inner passageway and being configured to cover the fastener head of the molly bolt fastener installed in the wall. The mounting assembly is positioned over the molly bolt head, and a threaded bolt is inserted into the passageway to mount the assembly to the wall. The method further includes the step of tightening the threaded bolt to force a bottom gasket of the mounting assembly against the wall to form a moisture seal surrounding the molly bolt fastener head. In an exemplary embodiment of the method, the mounting assembly is positioned to cover an upper portion of a Fab-Lok® brand fastener that protrudes from a wall surface, and tightened into place to provide a moisture seal between the mounting assembly and the wall structure, thereby providing a moisture sealed mounting assembly with a mounting surface positioned at a spaced distance from the wall surface for securing a supported element to the wall.

A better understanding of the invention will be obtained from the following detailed description and accompanying figures, which set forth illustrative embodiments that are indicative of the various ways in which the principals of the invention may be employed.

### BRIEF DESCRIPTION OF THE DRAWINGS

FIG. 1 is a perspective view of an exemplary mounting assembly in accordance with certain embodiments for securing supported elements to a wall structure;

FIG. 2 is a partial section of FIG. 1, with a cross-sectional side view of an exemplary mounting assembly in accordance with certain embodiments;

FIG. 3 is an exploded view of an exemplary mounting assembly in accordance with certain embodiments for securing supported elements to a wall structure, having individual components comprising an elongated body of the assembly, an upper shank gasket configured to be inserted into a cavity at an upper end of the elongated body to provide an upper moisture seal, and a bottom gasket configured to provide a circumferential moisture seal.

FIG. 4 is a cross-sectional side view of a mounting assembly in accordance with certain embodiments, wherein the mounting assembly is positioned to cover a protruding upper portion of a molly bolt fastener installed into a wall panel;

FIG. 5 is a cross-sectional side view of a mounting assembly of FIG. 4 in accordance with certain embodiments, wherein the mounting assembly is secured to the molly bolt fastener with a threaded bolt and secured to the wall panel to provide moisture seal;

FIG. 6 is bottom view of the mounting assembly in accordance with certain embodiments;

FIG. 7 is an elevated perspective view of an exemplary mounting assembly secured to a wall structure, providing a mounting surface for securing a supported element at a spaced distance from the wall, in accordance with certain embodiments;

FIG. 8 is a cross sectional view of a prior art mounting assembly and method for securing a supported element to an insulated metal panel wall structure with use of molly bolt fasteners.

Illustrative and exemplary embodiments of the invention are described in further detail below with reference to and in conjunction with the figures.

### DETAILED DESCRIPTION OF DRAWINGS

The description that follows describes, illustrates and exemplifies one or more embodiments of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that are understood in accordance with these principles and illustrated examples. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features. As stated above, this specification is intended to be taken as a whole and interpreted in accordance with the principles of the invention as taught herein and understood by one of ordinary skill in the art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

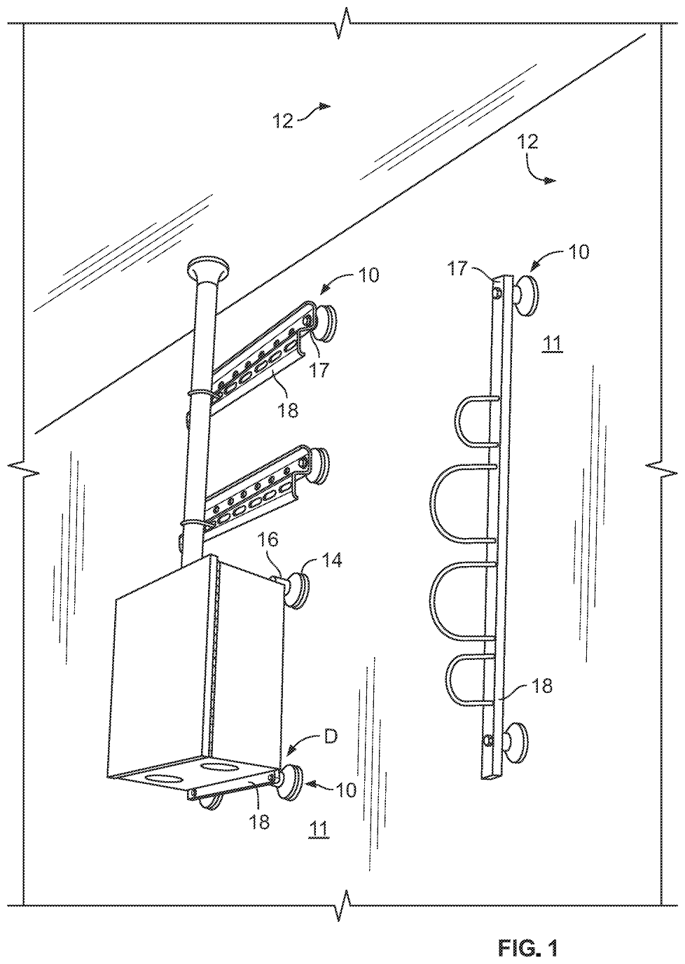

FIG. 1 is a perspective view of a wall structure with installation of exemplary mounting assembly 10 in accordance with an embodiment of the present invention. The assembly is configured to provide mounting of a supported element 18 to wall structure 12, shown in the figures as an upright (vertical) interior wall structure and which alternatively may be a differing wall structure comprised of a substantially planar surface, such as a ceiling or exterior of a building. In the embodiment shown, the mounting assembly 10 is secured to the wall structure 12 such that a lower end 14 of the assembly 10 engaged with the surface 11 of the wall structure 12, and an upper end 16 of the assembly 10 has a support surface 26 that is positioned and configured to provide a mounting position 17 for engaging (and securing) a supported element 18 at a distance spaced from the surface of the wall structure 12. The supported element 18 may be selected from a variety of structures intended to be secured to the wall structure, such as a bracket, conduit, a pipe or other supported structure that is desired for the particular application.

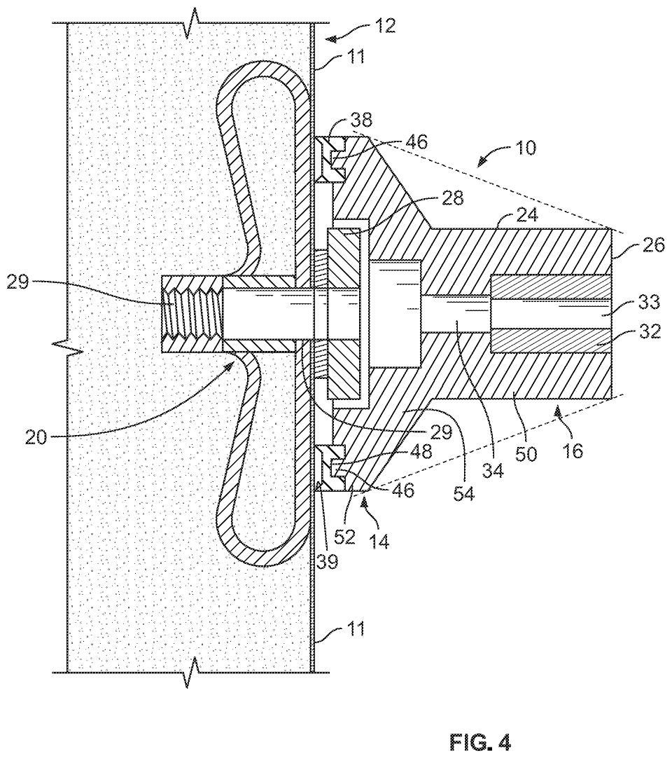

For example, the assembly 10 may be used to secure a mounting bracket and conduit to the wall structure 12 in a food processing facility, wherein at least an extent of the supported element 18, when installed and secured in place, is positioned a suitable distance (D) away from the surface 11 of the wall 12. In this manner, the assembly 10 and the associated method of installing the assembly 10, provides a support surface 26 for attaching a supported element 18 to the wall structure 12 at a specific distance (D) away from the surface 11 of the wall structure 12, such as may be desired or required for certain environments and uses. In one example, the assembly 10 is secured to a wall structure 12 that is constructed of insulated metal panels (IMP's) that are commonly used for environments such as food processing or pharmaceutical manufacturing facilities. The mounting assembly 10 is secured to the IMP panel of the wall structure 12 with the use of a molly-bolt fastener assembly 20 (shown in FIG. 4), wherein the mounting assembly 10 is positioned to cover an upper portion of the molly-bolt assembly 20 (comprising a molly-bolt head 28) that protrudes from the surface 11 of the wall structure 12, which is described in further detail herein.

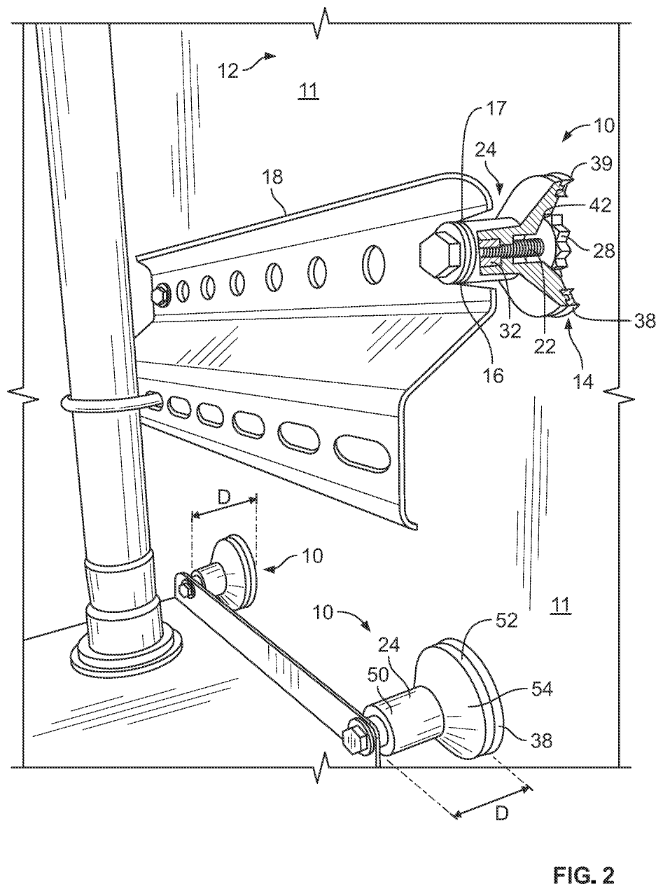

The upper end 16 of the assembly 10 provides at least one upper mounting surface 26 located at a mounting position 17 that is a distance (D) from the wall surface, such as one-inch distance from the wall surface 11 as may be required for a specific application in food processing or similar facilities. As shown in the example of FIG. 2, the mounting assembly 10 may be used to mount a supported element 18, such as a strut member or other wall hanger for attaching a pipe, conduit, or other element to the wall or ceiling. The mounting assembly 10 is positioned over the exposed upper portion of the molly bolt assembly 20, shown as an upper flange or molly bolt head 28 protruding from the wall surface 11, and is secured in place using a threaded bolt 22 that passes through a central passageway 34 of the elongated body 24 and inserted into the threaded opening in the wall 12 (shown in the figures as a threaded molly-bolt fastener 20 that is installed in the wall 12). The threaded bolt 22 is also preferably used to secure the supported element 18 abutted against the mounting surface 26 at the upper end 16 of the elongated body 24.

In this embodiment, as shown in FIGS. 2, 4 and 5, the threaded bolt 22 has a length suitable for passing through the length of the elongated body 24 and extend into the threaded segment of the molly-bolt fastener that resides withing the wall structure 12. More specifically, the elongated body 24 of the assembly 10 has an inner passageway 34 that extends between a first end (lower end 14) of the body and a second end (the upper end 16) of the body, wherein the inner passageway 34 is dimensioned to receive and permit passage of the bolt 22 through the length of the elongated body 24, to secure the mounting assembly 10 to the wall structure 12.

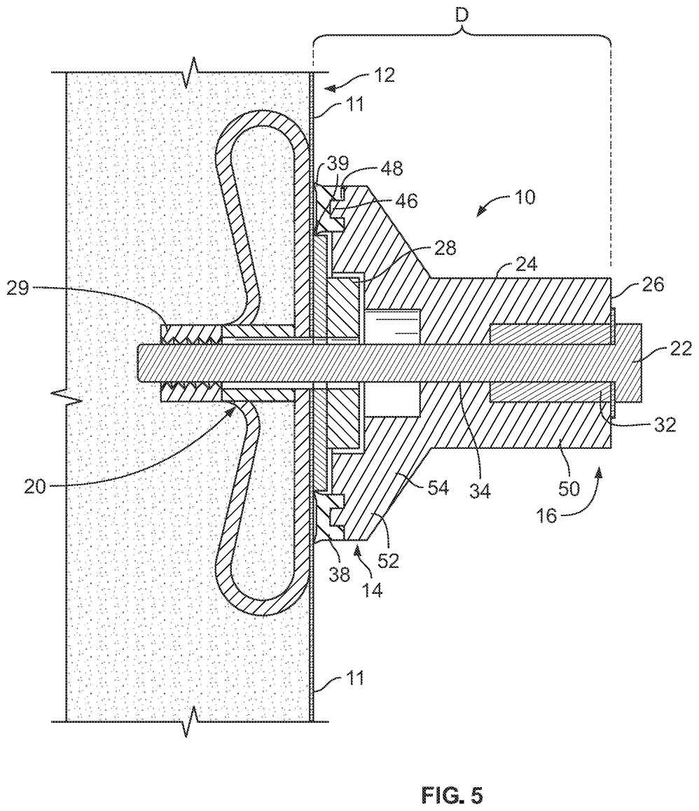

In an embodiment, the mounting assembly 10 is configured to be used to secure a supported element to the wall structure 12 comprised of insulated wall panels (such as Insulated Metal Panels commonly used for construction of manufacturing facilities) that are joined together to form a wall. The mounting assembly 10 may be mounted to a molly-bolt fastener device 20 that is already installed in the wall 12, such as for securing panels together, or used with a molly-bolt device that is installed at a desired location. Installation of a molly-bolt device 20 results in an upper collar portion of the molly bolt, along with a gasket washer that may optionally reside between the upper collar and the surface 11 of the wall 12, results in a molly bolt anchor head 28 that protrudes from the surface 11 of the wall 12. The anchor assembly includes a central opening 29 into the wall 12, such as is shown in FIGS. 4 and 5. A common example of this type of molly bolt fastener installation, as shown in FIGS. 4 and 5, is a Fab-Lok® molly bolt device, or similar type of threaded blind fastener which results in an upper collar (a molly bolt head 28) that resides on and protruding from the surface 11 of the wall 12. This type of device thereby is configured to provide an exposed threaded opening 29 of the surface 11 of the wall 12. The mounting assembly 10 of the present disclosure provides a superior method of attaching a supported element (such as a bracket) to the wall 12, utilizing the threaded opening of a molly bolt fastener device, while overcoming the obstacle presented by the molly bolt head 28 residing on, and protruding from, the wall surface 11. Further, the mounting assembly 10 and the associated method for mounting a supported element 18 to a wall, provides allows for removably securing a supported element to a wall, rather than being permanently mounted such as is common in the prior art (FIG. 8).

In an embodiment, the mounting assembly 10 is configured to have an inner void area 40, located at the lower end 14 of the elongated body 24. The inner void area 40 is dimensioned to provide a cavity space that is dimensioned to receive and thereby cover the molly bolt head 28. In an embodiment shown (FIG. 2, and 4-6), the inner void area 40 is a cavity that is defined by an inner sidewall arrangement 44 located adjacent the lower end 14 of the assembly 10. The cavity, or void area, 40 is dimensioned to provide an inner space that is approximately 0.25 inches high and approximately 0.75 inches in diameter. The dimensions of the void area 40 may differ depending on the associated molly bolt head 28 used, so that the void area 40 provides adequate space to receive the greatest height and width of the molly bolt head 28, to cover the head 28 such that the lower end 14 of the assembly 10 completely surrounds the molly bolt head 28.

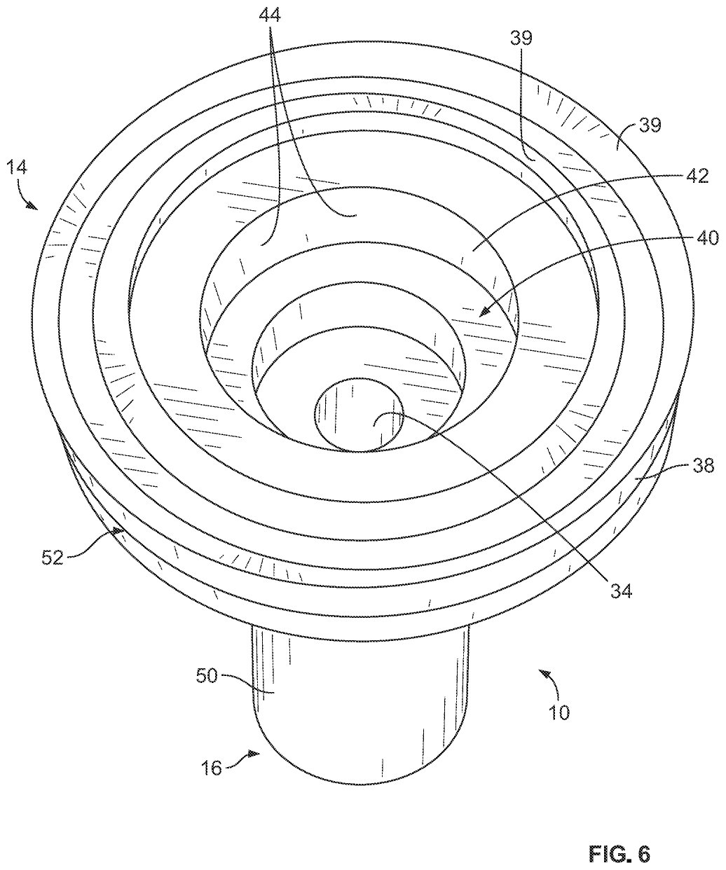

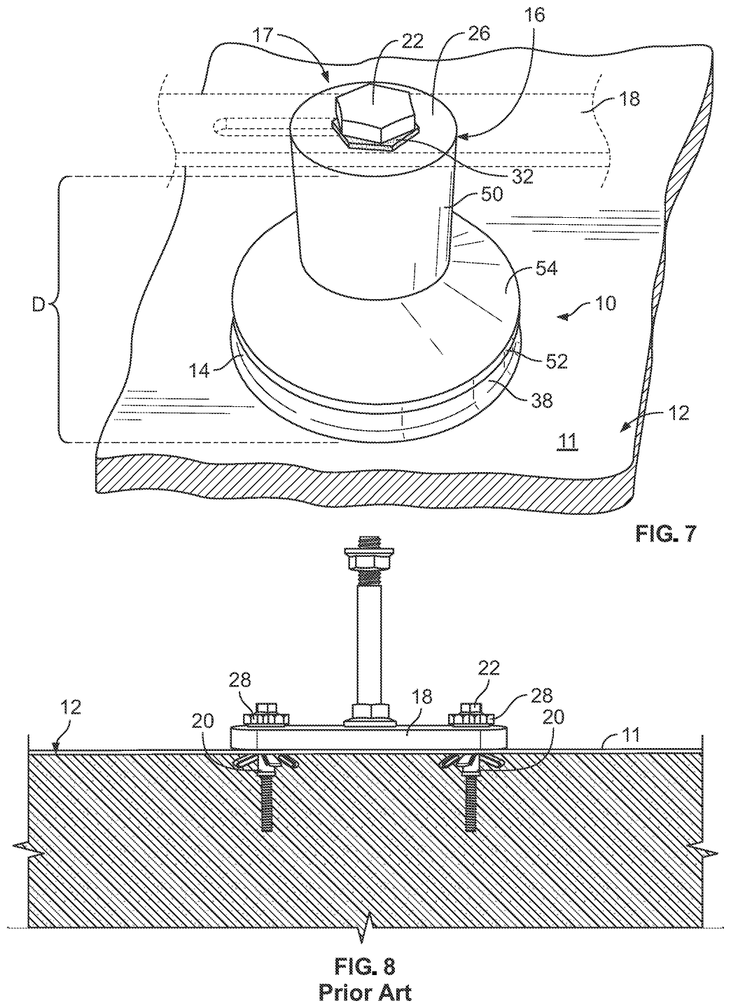

In the embodiment shown in FIG. 6, the void area is defined by an inner sidewall arrangement 44 that is circular, wherein the circular sidewall 42 defines inner void region that is wider than a common molly bolt head 28. In an alternative embodiment (such as is shown in FIG. 2) the inner sidewall 42 has a sidewall arrangement 44 that is configured to substantially mate with an outer shape of the molly bolt head 28. In such an embodiment, for example, the inner sidewall arrangement 44 may form a void area 40 with sidewalls that substantially mate with the 12-pointed flange head of a molly bolt head 28 of a Fab-Lok® fastener device. In this embodiment, wherein at least a portion of the sidewall arrangement 44 substantially mates with the molly bolt head 28, the mating arrangement of the shape of the sidewall 42 and the shape of the molly bolt head 28 results in engagement between the assembly 10 and the molly bolt head 28 to prevent or limit rotation of the assembly 10 when installed.

A bottom gasket 38 is integral with a rigid body portion 24, preferably attached to the lower end 14 of the elongated body 24 to provide and end gasket surface on the bottom of the assembly 10. The bottom gasket 38 is preferably formed as a circumferential ring of rubber-like material that surrounds the inner passageway 34 and which is configured to be positioned to engage with a mating area of the wall surface 11 to form a moisture barrier surrounding the inner passageway 34 when the mounting assembly 10 is secured in place. This structure provides a gasket seal surrounding the molly bolt head 28 when the assembly 10 is installed in a mounted position on a wall 12. At least a portion of the bottom gasket 38 may be formed of a suitable compressible material that is desired or necessary for a particular application, preferably formed of either rubber, silicone, a synthetic rubber such as neoprene (polychloroprene), nitrile, acrylic, urethane, EPDM (ethylene propylene diene monomer), or PTFE (polytetrafluoroethylene).

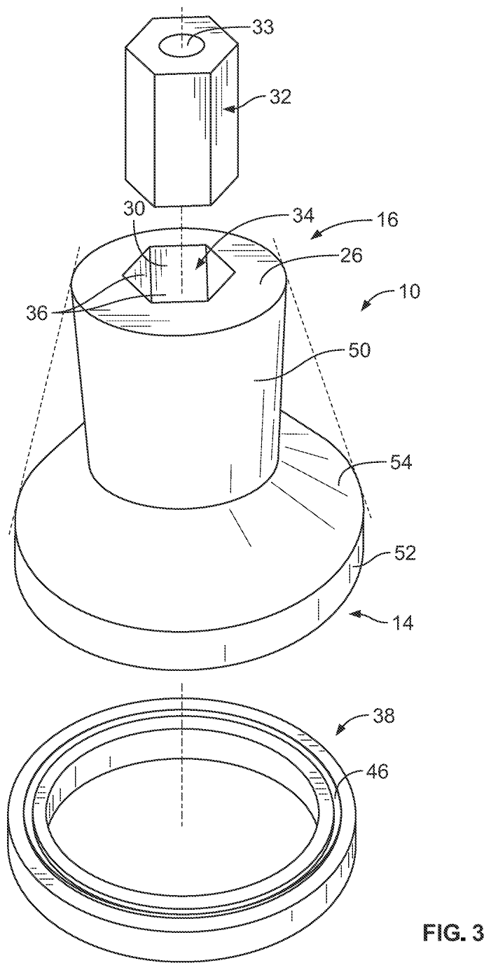

In an embodiment, the bottom gasket 38 is attached to the rigid elongated body by an arrangement of a projection 46 and a mating receiver 48, wherein a projection is located on either the bottom gasket 38 or the rigid body 24 and a receiver is located on the other of the portion, i.e., the other of either the gasket 38 or rigid body 24. In the embodiment shown in the Figures, such as FIGS. 3 and 4, the bottom gasket member 38, which is a ring formed of soft rubber-like gasket material, has a circumferential groove as a receiver 48. This receiver 48 is dimensioned to substantially mate with a projection 46 on the lower end 14 of the rigid body 24, wherein the projection 46 is inserted into the receiver 48 to provide a frictional engagement for securing the bottom gasket 38 to the rigid body 24. This arrangement, wherein a circumferential projection 46 that protrudes from the lower end 14 of the rigid body 24 is inserted into a circumferential receiver 48, or channel, formed in the gasket 38, maintains the position of the gasket 38 when it is compressed as the assembly is tightened onto the wall 12. Thus, in an embodiment, the bottom gasket 38 is preferably formed as a ring of gasket material that has an upper circumferential groove (as a receiver 48) which, when assembled and fastened to the wall 12, a protruding circumferential ring extending from the bottom of the rigid body (a projection 46) is mated with and resides within in the groove. It is contemplated that other similar or partial structures that provide mating engagement of a projection 46 and receiver 48 may be utilized. For example, the arrangement of a mating projection 46 and receiver 48 may include segmented protrusions and mating recesses or groves, rather than a continuous arrangement of a circumferential ring-like protrusion and mating groove. Alternatively, the mating arrangement of a projection 46 and receiver 48 may comprise a grove located on the rigid body 24 and an upper portion of the gasket 38 is a projection that resides within the groove.

The bottom gasket 38 preferably has a lower surface with at least one protruding ridge 39 of gasket material that provides an improved gasket sealing end surface when positioned against a surface 11 of the wall 12. In the embodiment shown in the Figures, the bottom gasket 38 has two protruding ridges 39, formed as concentric rings of gasket material on the lower surface of the bottom gasket 38 (FIG. 6) that extend downward to engage with the surface 11 of the wall 12 (FIG. 4). More specifically, in the embodiment shown and described herein, the assembly 10 has a lower gasket 38 with ridges 39 having pointed terminal ends that engage with, and are compressed against, the wall surface 11, as is shown in FIGS. 4 and 5. As shown in FIG. 5, when the assembly 10 is secured to the wall 12 with a mounting bolt 22, the bottom gasket 38 is compressed against the surface of the wall, such that the terminal portion of the protruding ridges 39 of the bottom gasket 38 are forced against the wall surface 11, thereby providing a circumferential seal along the wall surface 11 to block moisture from entering into the area surrounding the molly bolt head 28. This circumferential moisture seal surrounding the molly bolt head 28 and the inner passageway 34 of the assembly 10 prevents contamination, such as dust and moisture, from entering the area of the assembly body 24 that covers the head of the molly bolt. This structure, and the method of installation, provides a moisture barrier that surrounds the inner void area 40 of the mounting assembly 10 wherein the inner void area 40 is configured to receive and fully cover the molly bolt head.

In the embodiment shown in the Figures, the elongated body 24 includes an upper portion 50 and a lower portion 52, wherein the lower portion 52 has a greater diameter relative the outer diameter of the upper portion 50, thus forming an overall generally conical shape of the body 24. In the embodiment shown in FIGS. 3 and 4, this generally conical shape of the assembly 10 is shown with dashed lines depicting the overall shape defined by the outer edge of opposed sides of the body 24. In one form of this embodiment, the upper and lower portions (50, 52) are generally cylindrical and a central portion 54 of the elongated body 24 has a substantially conical shape as a transition between the upper and lower body portions, such as is shown in FIGS. 3-5. In one example of this embodiment, the upper portion 50 has an outer diameter of approximately 0.75 inch and the lower portion 52 has an outer diameter of approximately 1.50 inch. This arrangement of a narrow upper portion 50 and a widened lower portion 52 is configured to provide a mounting surface 17 at the upper end 16 of the body 24 for attaching a supported element 18 at a location that is a distance (D) spaced from the surface 11 of the wall 12, and wherein the body 24 has a widened area of the body 24 to provide an enlarged lower end 14. The widened lower portion 52 is dimensioned to completely surround the molly bolt head 28 (and threaded opening of the molly bolt assembly 20) that protrudes from the wall 12, and is configured to distribute the compressive load exerted when securing the assembly 10 to the wall 12 using a mounting bolt that extends through the body 24.

Preferably, at least an extent of the elongated body 24 is formed of rigid plastic material and each segment of the elongated body (i.e., each of the upper portion 50 and lower portion 52 and central portion 54) is configured to have a generally curved outer surface, preferably a substantially smooth curved outer surface, which minimizes collection of dust or moisture. This feature of the body 12 having a generally curved outer shape, without a flat surface that is prone to collection of dust, is advantageous in certain applications such as food preparation facilities, where collection of dust and debris on surfaces may be hazardous or require frequent cleaning. Further, the elongated body 24 has a height that provides a mounting surface 17 (a location for mounting a supported element 18) that is at a suitable distance (D) from the wall 12, which is useful for facilitating cleaning the wall 12.

The assembly also includes a shank gasket 32 that is positioned at the second end (the upper end) 16 of the elongated body 24, preferably at least partially inserted into a cavity 30 that is aligned with the inner passageway 34 of the body 24. The shank gasket has a central opening, preferably passing through the length of the gasket, wherein at least an extent of the central opening 33 extending through the shank gasket 32 has a narrow diameter relative the passageway 34 of the elongated body 24. The narrow diameter of the shank gasket opening 33 is configured to be at least slightly smaller than the outer diameter of the mounting bold 22, such that the shank gasket 32 is compressed against the shank of the bolt to form a moisture seal surrounding at least a portion of the bolt 22 when the bolt 22 is inserted through the assembly 10 for mounting the assembly 10 to a wall structure 12.

The upper end 16 of the elongated body 24 also preferably has an internal cavity 30 (shown in FIG. 3) for receiving a bolt shank gasket 32 that is configured to engage with a shank portion of the threaded fastener 22 to provide a moisture seal that blocks moisture from entering into the inner passageway 34 of the elongated body 24. The shank gasket 32 positioned at the upper portion of the mounting assembly is comprised of a grommet of rubber-like gasket material that is positioned adjacent (and preferably at least partially within an upper cavity of) the upper end 16 of the elongated body 24. In an embodiment, the upper cavity that receives the grommet shank gasket has an inner sidewall arrangement 36 that is configured to resist rotation of the grommet body of the gasket 32 within the cavity 30. The inner sidewall arrangement 36 of the cavity 30 preferably is formed as a hexagonal sidewall arrangement, and the grommet body of the shank gasket 32 has an outer surface 37 substantially mating with the hexagonal sidewall arrangement 36. As shown in FIG. 3, the mounting assembly is assembled by inserting the shank gasket 32 (shown as a hexagonal grommet) into the mating cavity 30 (shown as a hexagonal shaped cavity formed of a sidewall arrangement 36 within the rigid elongated body 24) which provides a mating and indexed fit between the gasket 32 within the cavity 30 to prevent rotation of the shank gasket 32 when the assembly 10 is secured to a wall 12. Thus, when the bolt 22 engages the central opening 33 of the shank gasket 32, thus providing a moisture seal along at least a portion of the shank of the bolt 22, the gasket 32 is maintained in position and prevented from rotating within the cavity 30.

In some embodiments, the mounting assembly 10 may be provided as a kit for mounting a support element 18 to a wall structure 12. Such a kit may include one or more tools configured to facilitate the installation, such as, for example, a driver (e.g., drill bit, ratchet, etc.) or other suitable tool. In an embodiment of the kit according to the present invention, each of the components described herein may be provided together, optionally in a package containing the collection of parts for a full assembly of the device or optionally in a collection of parts for multiple assemblies. The kit may also include alternative parts for a user to select an appropriate option for the environment and the wall structure, such as alternative thickness and construction of the bottom gasket 38 to provide differing thickness of compressible material to accommodate situations in which the surface of a wall is undulated or rough, or alternative shank gaskets 32 which may be employed to accommodate differing shank dimensions of particular bolts 22 selected for use.

It should be emphasized that the above-described embodiments, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and protected by the following claims.

I claim:

1. A mounting assembly for securing a supported element to a laminated wall panel having protruding molly bolt anchor head surrounding a threaded opening, comprising:
an elongated body formed of rigid plastic having an inner passageway passing between a lower end and am upper end of the body, wherein said inner passageway is configured to receive a bolt through the elongated body for securing the mounting assembly to the wall structure;
a bottom gasket is attached at said lower end of the elongated body, said bottom gasket being formed of a circumferential ring of rubber-like material surrounding the inner passageway and configured to engage with a wall surface to form a moisture barrier surrounding said inner passageway; and,
a shank gasket positioned at said upper end of the elongated body, said shank gasket having a central opening aligned with said inner passageway, wherein said opening of the shank gasket is configured to form a moisture seal surrounding a shank portion of a bolt when inserted through the elongated body for mounting said elongated body to a wall structure.

2. The mounting assembly of claim 1, wherein an extent of said elongated body has an outer shape comprised of an upper cylindrical portion and a lower cylindrical portion, wherein said lower cylindrical portion has a greater diameter than a diameter of said upper portion, and wherein said upper cylindrical portion and lower cylindrical portion are separated by a conical central portion.

3. The mounting assembly of claim 2, wherein the upper portion has an outer diameter of approximately 0.75 inch and said lower portion has an outer diameter of approximately 1.50 inch.

4. The mounting assembly of claim 1, wherein said lower end of the elongated body has an inner void area configured to cover a molly bolt anchor head protruding from the wall panel.

5. The mounting assembly of claim 3, wherein said inner void area is defined by an inner sidewall having dimensions substantially mating outer dimensions of an anchor bolt flange head.

6. The mounting assembly of claim 3, wherein said inner void area is defined by an inner sidewall having a circumferential shape configured to substantially mate with a 12-pointed flange head.

7. The mounting assembly of claim 1, wherein the bottom gasket is attached to the rigid body by an arrangement of a projection and a mating receiver, wherein a projection is located on either the bottom gasket or the rigid body and a receiver is located on the other of said gasket or rigid body.

8. The mounting assembly of claim 7, wherein the bottom gasket comprises a ring of gasket material having has an upper circumferential groove, wherein a mating circumferential projection of the upper body resides in the groove.

9. The mounting assembly of claim 8, wherein the bottom gasket has a lower surface with a protruding ridge of gasket material.

10. The mounting assembly of claim 1, wherein said shank gasket comprises a grommet of gasket material positioned within an upper cavity at the second end of said elongated body.

11. The mounting assembly of claim 10, wherein said upper cavity has an inner sidewall configured to resist rotation of the grommet within the cavity.

12. The mounting assembly of claim 11, wherein said inner sidewall has a hexagonal sidewall arrangement and said grommet has an outer surface substantially mating with said hexagonal sidewall arrangement.

13. A mounting assembly for securing a supported element to a wall structure, the mounting assembly comprising:
an elongated body having an inner passageway which extends between a first end and a second end of the body, said inner passageway having a diameter configured to receive a bolt through the elongated body for securing the mounting assembly to the wall structure;
said first end having a circumferential bottom gasket comprised of compressible material surrounding the inner passageway, wherein said bottom gasket is configured to engage with the wall structure to form a moisture seal surrounding said inner passageway; and,
a shank gasket positioned within said elongated body adjacent said second end, said shank gasket having a central opening aligned with said inner passageway, wherein said opening of the shank gasket is configured to form a moisture seal surrounding a shank portion of a bolt when inserted through the elongated body.

14. The mounting assembly of claim 13, wherein said first end of the elongated body is configured to cover a molly bolt anchor head protruding from the wall panel.

15. The mounting assembly of claim 13, wherein said first end of the elongated body has an inner void area that is dimensioned to receive a molly bolt anchor head protruding from a wall.

16. The mounting assembly of claim 15, wherein said inner void area is defined by an inner sidewall having dimensions substantially mating outer dimensions of an anchor bolt flange head.

17. The mounting assembly of claim 13 wherein said elongated body has a length that is at least one inch, such that a support element secured to the second end of the mounting assembly will be positioned at least one inch from the wall structure.

18. The mounting assembly of claim 17, wherein the elongated body has an outer shape comprised of a cylindrical sidewall arrangement.

19. The mounting assembly of claim 18, wherein the elongated body has an upper portion and a widened base portion, said upper portion and said base portion being connected by a generally conical central portion.

20. The mounting assembly of claim 19, wherein the upper portion has an outer diameter, and said widened base portion has an outer diameter approximately twice said outer diameter of the upper portion.

21. The mounting assembly of claim 13, wherein said circumferential bottom gasket is comprised of a comprisable ring secured to a rigid portion of said elongated body, said ring having an inner diameter and having an outer diameter.

22. The mounting assembly of claim 21, wherein the compressible ring is secured to said rigid portion by an arrangement of a projection and a mating receiver, wherein said projection is located on either the ring or rigid portion and said receiver is located on the other of said either the ring or rigid portion.

23. The mounting assembly of claim 21, wherein the compressible ring has a lower gasket surface and an upper surface, and said upper surface has at least one recess configured to receive a mating projection of an adjacent rigid portion of the elongated body.

24. The mounting assembly of claim 23, wherein said at least one recess includes a circumferential groove in the compressible ring which is configured to receive a mating circumferential projection of said adjacent rigid portion.

25. The mounting assembly of claim 21, wherein the compressible ring has a lower gasket surface with at least one circumferential projection.

26. The mounting assembly of claim 25, wherein said at least one circumferential projection of the lower gasket surface comprises an outer projection of gasket material located at the outer edge of the gasket and an inner projection located at an inner edge of the gasket.

27. The mounting assembly of claim 21, wherein at least a portion of said bottom gasket is formed of one of a group of materials comprising rubber, silicone, neoprene, nitrile, acrylic, urethane, EPDM, or PTFE.

28. The mounting assembly of claim 13, wherein said shank gasket is formed of a grommet body formed of rubber-like material, and said central opening has a diameter that is smaller than the diameter of the central passageway.

29. The mounting assembly of claim 28, wherein the elongated body has an upper cavity at said second end and at least an extent of said grommet body has an outer shape configured to mate with said upper cavity.

30. The mounting assembly of claim 29, wherein said upper cavity has an inner sidewall configured to resist rotation of the grommet body within the cavity.

31. The mounting assembly of claim 30, wherein said inner sidewall of the upper cavity comprises a plurality of flat segments and said grommet body has outer surfaces configured to mate with said flat segments of the cavity.

32. The mounting assembly of claim 31, wherein said cavity has a hexagonal sidewall arrangement and said grommet body has an outer hexagonal shape.

33. A method of securing a support element to a molly bolt anchor installed in a wall structure wherein the molly bolt anchor has a threaded opening, the method comprising the steps of:
providing a mounting assembly having an elongated body with an inner passageway extending between a first end and a second end of the body, said inner passageway having a diameter configured to receive a bolt through the elongated body for securing the mounting assembly to the wall structure and said first end comprises a bottom void area surrounded by a bottom gasket;
positioning said mounting assembly over the threaded opening of the molly bolt anchor, such that the void area covers a top of the molly bolt anchor and said bottom gasket is engaged with a surface of the wall;
inserting a threaded bolt into said inner passageway of the elongated body, wherein the threaded bolt passes though the body and is treaded into the threaded opening of the molly bolt anchor;
tightening the threaded bolt into the threaded opening to force the bottom gasket against the wall such that the bottom gasket is compressed against the wall to form a moisture seal surrounding the threaded opening of the molly bolt anchor.

34. The method of claim 33 wherein the method further comprises the steps of
providing a shank gasket inserted into said second end of the elongated body, the chank gasket having a central opening dimensioned to engage with an outer portion of the threaded bolt when inserted through the elongated body; and,
said step of inserting the threaded bolt into the inner passageway includes the step of forcing the bolt through the shank gasket.

35. The method of claim 33, wherein the step of positioning said mounting assembly over the threaded opening of the molly bolt anchor includes the step of aligning the elongated body over a head portion of the molly bolt anchor that protrudes form the wall, such that the head portion is inserted into the void area of the elongated body and said gasket surrounds the head portion of the molly bolt anchor.
